(19) United States
(12) Patent Application Publication
(10) Pub. No.: US 2004/0102302 A1
(43) Pub. Date: May 27, 2004

(54) Tissue curly cued packaging materials and the method for manufacture thereof

(76) Inventor: Stephen B. Stepanek, Amherst, NH (US)

Correspondence Address: Stephen W. White, Stephanor Consulting Services, Inc., P.O. Box 350, Sunapee, NH, 03782, US

(21) Appl. No.: 10/305,323

(22) Filed: Nov. 27, 2002

(51) Int. Cl. B31B 1/36

(52) U.S. Cl. 493/459

(57) ABSTRACT

A product comprising curly cued tissue paper packaging material and a method for making said product are described. The method employs feeding a substantially continuous web of tissue paper material having a weight of between 1 pound and 20 pounds per 3,000 square feet of tissue paper under tension over at least one knife edge prior to slitting and cutting the paper web into desired widths and lengths. The results are a curly cue product that makes superb packing material for any number of delicate elements that need to be shipped and is eminently useful in decorative packaging. The product described herein is easy to use, has considerably more packing value than other paper packing products and is environmentally safe.

### RELATED APPLICATIONS

This application is related to my co-filed patent application entitled “Paper Curly Cued Packaging Materials and the Method of the Manufacture Thereof”, SS-500 and is also related to my co-filed Provisional Patent entitled “Curly Cued Plastic Packaging Materials and the Method for the Manufacture Thereof”, SS-600-Prov.

### BACKGROUND OF THE INVENTION

1. Field of the Invention

This invention relates to the field of packaging materials and more specifically to packaging materials made out of tissue paper materials. Even more specifically this invention relates to packaging materials that can be used to package bulk materials of any kind as well as decorative packaging. Still more specifically this invention relates to tissue paper packaging materials made into a curly cued format.

2. Description of the Prior Art

There are a host of packaging materials used in the prior art to pack around and protect items to be shipped, contained or stored. These include such materials as Styrofoam pellets, peanuts or other formed and loose materials that can be packed in and around these items to protect them during shipment, handling, storing and the like. In addition to these prior art materials it is well known to make packaging materials from paper and the like. These prior art paper formed packaging materials are conventionally formed into folded or crimped shape and are used to decoratively package materials as well as to pack around and protect items to be shipped, contained or stored. In addition, it is well known to make packaging materials from wood products. One of these last products is known by the name Excelsior® and these are formed in a semi-curly cued shape.

Most of these prior art packaging materials have a number of drawbacks. The Styrofoam products are extremely light and heavy objects packaged within this product tend to gravitate towards the bottom of the container and thus the effect of the packaging material may be lost. Also, these packaging materials are not particularly environmentally friendly and are extremely light and can be blown about during handling and thus end up within the ecosystem. If these Styrofoam materials end up in standard disposal systems and are either buried or burned, they can cause havoc. Burying them is not a preferred option since they are considered nonbiodegrable. Burning these elements sometimes results in the emission of toxic gasses. Thus, there is a movement away from these synthetically produced packaging materials towards more environmentally friendly elements.

Packaging elements made from paper are also extensively used in the prior art. These elements are conventionally manufactured from papers that may be treated in some manner prior to being processed through complicated machinery that will impart a pre-formed folded and crimped shape when the paper is further cut into strips and exits the machinery. A particular example of this prior art material is contained in U.S. Pat. No. 5,656,008 and to the plethora of references contained therein. Although these folded and crimped packaging materials are currently widely used, they do not possess enough packing volume per amount of paper used in their manufacture and thus more of this material must be used. In addition, these packaging materials do not have a soft feel and resilience and do not present enough air space to be used efficiently.

Curly packaging products made from woods are well known in the prior art. These are conventionally known as Excelsior® products and have been used for more than 100 years as a material to pack in and around delicate objects to assist the shipment thereof. The drawback to these Excelsior® products is that they are made of wood and thus are more expensive to manufacture. Additionally, these elements are not conventionally used to ship delicate food and floral products since they can exude materials that can cause damage or impact the flavor of such shipments.

Thus, there is a pressing need within the industry for a relatively inexpensive, easy to use, environmentally safe packaging material that can provide sufficient packing space and will cover and hold the packaged materials during the shipment thereof. There is also a need for packaging materials that can be used in a decorative manner and will not exude harmful vapors and the like.

### SUMMARY OF THE INVENTION

It is an object of this invention to provide a new curly cued packaging material that can be manufactured out of tissue paper. It is a further object of this invention to provide such a product that will be environmentally safe and provide sufficient support to the material being shipped at a reasonable cost. It is also an object of this invention to provide a packing or packaging material that can be used in a decorative manner. These and yet other objects are achieved in a tissue paper packing material comprising a plurality of narrow, elongated strips of essentially flat, planar tissue paper material, said material having a natural resilience and each of said strips having a curly cue formation imparted thereto, wherein said tissue paper has a weight of 1 pound per 3,000 square feet to 20 pounds per 3,000 square feet. Still another element within the metes and bounds of this invention is a curled, tissue paper packing material comprising strips of pre-curled tissue paper, said strips having lengths of from 1 inch to 100 feet and widths of from 1/64^{th} to 2 inches, said tissue paper have a weight of from 1 pound per 3,000 square feet to 20 pounds per 3,000 square feet.

The aforementioned curled, tissue paper packing material may be made by a method in which a roll of tissue paper under tension is passed over at least one knife edge, drawn into a slicing machine designed to slice said tissue paper into widths of from 1/64^{th} to 2 inches and subsequently cut into lengths of from 1 to 100 feet, said tissue paper having a weight of from 1 pound per 3,000 square feet to 20 pounds per 3,000 square feet.

### BRIEF DESCRIPTION OF THE DRAWINGS

FIG. 1 is a showing of quantity of the material of this invention in a preferred width.

FIG. 2 is one strip of the material of this invention in a preferred length.

FIG. 3 is a schematic drawing showing the process by which the curly cue packaging material of this invention may be manufactured.

### DETAILS OF THE INVENTION

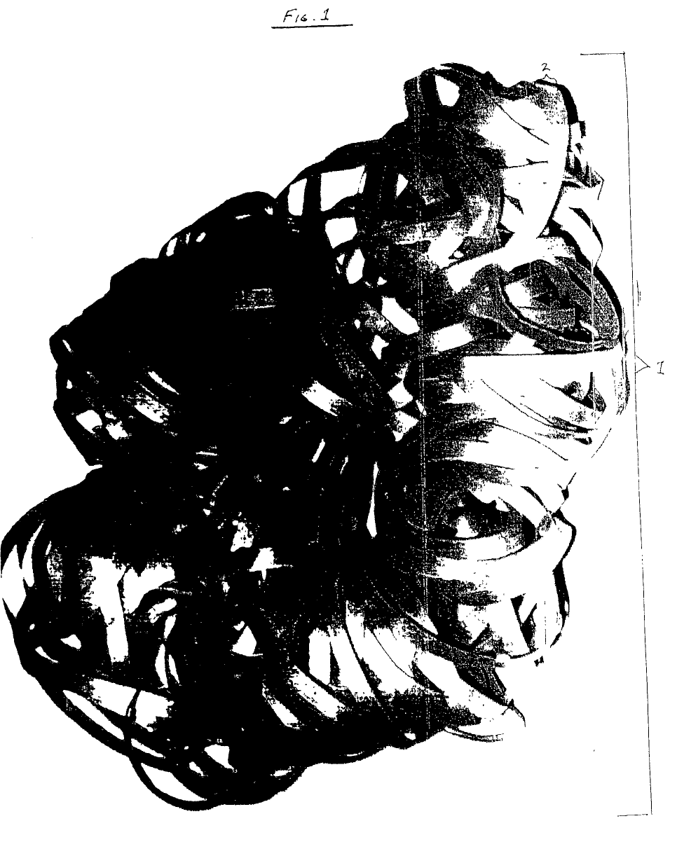

In FIG. 1, a quantity 1 of the packaging material of this invention prior to cutting into the desired lengths is shown. This material is prepared by passing a roll of tissue paper under tension over at least one knife blade and slitting the material into discrete widths, shown as 2 in this figure and this width may be from 1/64^{th} inch to 2 inches. The length of this material may be any desired length within the metes and bounds of this invention and as made for the desired packaging needs. For example, these slits of material may be up to 100 feet in length, forming a nice, curly cued packaging material for large items. Alternatively, it may be propitious to cut the lengths from 1 to 24 inches for other packaging needs. It is easy to see from this drawing that this material has a great deal of air space contained within the curly cue shape and thus will make an excellent packaging material.

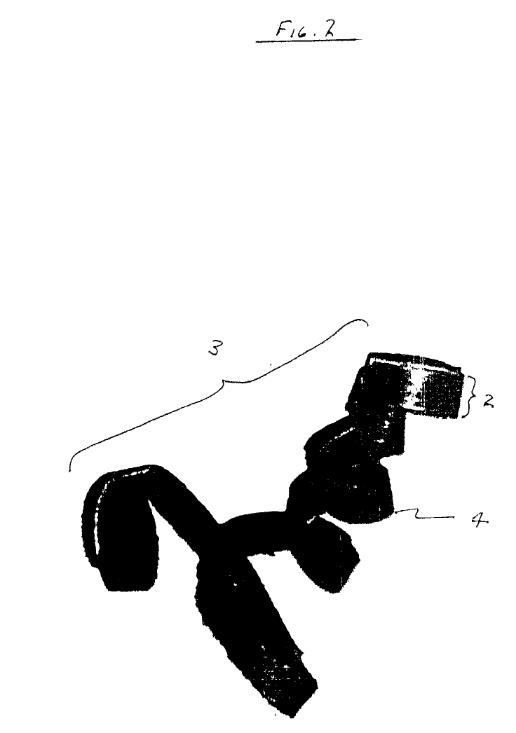

FIG. 2 shows a single strip 4 of the material from FIG. 1 after cutting. The length of this material is shown as 3 and this may be any of the preferred lengths of from 1 inch to 24 inches. In this particular view, the length is determined by straightening out the curly cues that make up the shape of the packaging material of this invention. Even after straightening out to measure, the material has a memory and will resume the curly cue shape that has been imparted thereon.

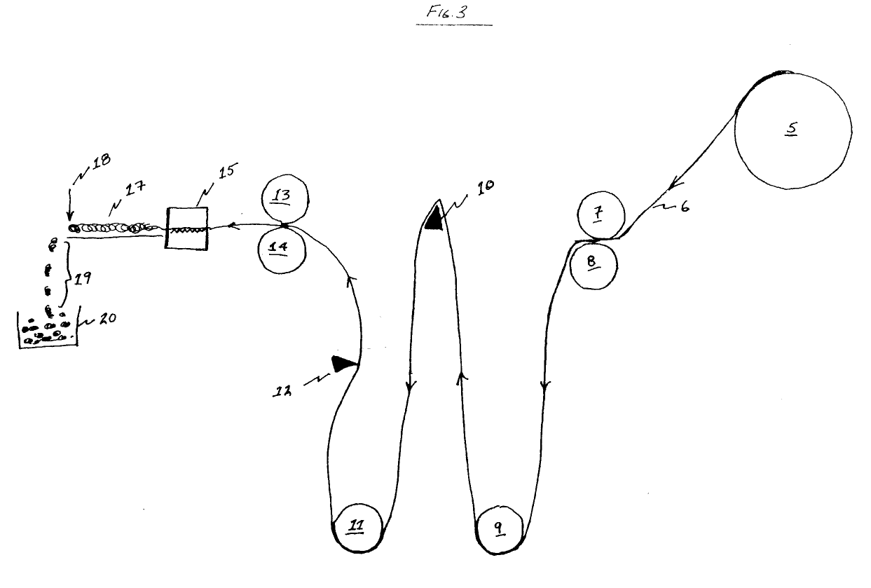

FIG. 3 is a schematic, side-view drawing of the machinery requisite to manufacture the curly cue packaging material of this invention. In this drawing 5 is a roll of tissue paper of any desired width and length shown on a tension roller. The web 6 travels in the direction shown by arrows through the first nip of a pair of pull rollers 7 and 8 and over a tension roller 9. The web is then shown passing over knife blade 10 and down over second tension roller 11 before passing over second knife blade 12 and from thence to a second nip of a pair of pull rollers 13 and 14. The tissue paper web now has the memory of a curly cue formation thereon and passes through slitter 15. As it exits the slitter, tension is relieved and the slitted material is shown in its curly cue formation as 17. A cutter at 18 may be designed to cut off the material into discrete lengths and these are shown as 19 falling off into storage box 20. Alternatively, and maybe preferably, it might be necessary to keep tension on the exiting and slitted web prior to cutting into the desired lengths. The material so produced is now suitable for use as a packaging material.

Curly cue tissue paper packaging materials made according to the teachings of this invention can be used to pack a plethora of products. For example, these packaging materials are suitable for packing in and around fresh fruits and vegetables. These packaging materials are also suitable for packing flowers and the like. Most prior art elements conventionally available are not suitable for any of these products. For example, Excelsior® type packaging materials made from wood products are not particularly suitable for flowers, fruits and vegetable shipments since the wood materials can exude vapors that can damage delicate, living materials. The use of Styrofoam pellets and peanuts are also not suitable since many of these products are made using various synthetic blowing agents that are not compatible with living materials such as flowers, fruits and vegetables. Other paper products can be used but they do not possess the packing ability of the curly cue packing made according to my teachings. My uniquely shaped curly cue tissue paper packing material can also be used for decorative packaging, e.g. in and around floral objects on display.

Starting material for the production of curly cue packaging products made according to the teachings of this invention will have a weight between 5 and 20 pounds per 3,000 square feet of tissue paper. A weight of between 10 and 15 pounds per 3,000 square feet of tissue paper is preferred. Curly cue packaging materials made with this range weight of paper is termed “tissue” and is particularly useful in packing in around the aforementioned living products, although they can be used to package any items that needs to be shipped. These tissue paper curly cue packaging materials may be plain tissue paper or alternatively may be tinted or dyed or coated with materials normally used to coat tissue papers. They may also be pre-printed if so desired. During the process of manufacture small amounts of moisture may be added if so desired. Alternatively, heat and/or moisture may also be applied during this process in order to impart other desirable modifications to the desired end product.

The machine used to make and manufacture the product of this invention is schematically shown in FIG. 3. In a preferred method of making the product of this invention one can look specifically at this drawing. Here the tissue paper stock is furnished on a roll of almost any desired width. Conventional widths are from 6 inches to 6 feet. This roll is loaded onto a tension feed roller shown as 5 in this drawing. The web 6 is then passed through the nip of a pair of opposing pull rollers 7 and 8 and then down over a first tension roller 9. From this position the web is shown passing over a first knife 10, over a second tension roller 11 and a second knife blade 12 and from thence through the nip of a second pair of opposing pull rollers 13 and 14. Finally, the web passes into a slitter 15 where it is slit into the desired widths. At this point, tension may be kept on the slitted web and the web then cut into the desired lengths or the web relaxed and the curly cue material cut into lengths at this time. What is shown in this Figure are the most preferable machine elements designed at the time of filing of this invention. Requisite to the formation of the curly cue shape of the tissue paper of this invention are at least one knife blade, although two are preferred and more blades may be used. These blades are conventional steel elements honed to a degree of sharpness designed to permit the web to traverse the length thereof without slicing or cutting the web itself. Other parts of the machinery such as rollers, slitters, etc. are conventional elements well known to those skilled in the art.

The tissue curly cue material of this invention may be of any width between 1/64 inches to 2 inches and any length of from 1 inch to 100 feet. I prefer using material of from 1/32^{nd} inch to ¼ inch in width (especially prefer ⅛^{th} inch) and from 4 inch to 12 inches in length (especially prefer 8 inches). This material makes an excellent packaging element in and around almost any delicate element to be shipped. I envision such tissue curly cue packaging material to be especially useful in shipping floral arrangements and the like, though the use is not specifically limited thereto. This material is soft and yet resilient and is perfect for use a packaging material yet it is easy to manufacture and environmentally friendly.

1. A tissue paper packing material comprising a plurality of narrow, elongated strips of essentially flat, planar paper material, said material having a natural resilience and each of said strips having a curly cue formation imparted thereto, wherein said paper has a weight of from 21 pounds per 3,000 square feet to 100 pounds per 3,000 square feet.

2. A curled, tissue paper packing material comprising strips of pre-curled paper, said strips having lengths of from 1 inch to 100 feet and widths of from 1/64^{th} inches to 2 inches, said paper having a weight of from 21 pounds per 3,000 square feet to 100 pounds per 3,000 square feet.

3. The packing material of claim 2 wherein said width is between 1/32^{nd} inches to ¼ inches and said length is between 4 inches to 12 inches.

4. The packing material of claim 1 wherein said paper as a weight of from 30 pounds per 3,000 square feet to 45 pounds per 3,000 square feet.

5. The packing material of claim 1 wherein said width is between 1/32^{nd} inches to ¼ inches and said length is between 4 inches to 12 inches.

6. A method for producing an essentially elongated, flat, planar curly cue tissue paper packing material from a substantially continuous web of tissue paper said tissue paper having a weight of between 1 pound and 20pounds per 3,000 square feet of paper material and passing said web under tension over at least one knife edge followed by slitting said web.

7. The method of claim 4 wherein said tissue paper has a weight of between 30 pounds and 45 pounds per 3,000 square feet of paper.

8. The method of claim 4 wherein said web is passed under tension over two or more knife edges prior to slitting into said widths and cutting into said lengths.

9. The method of claim 5 wherein said widths are between 1/32^{nd} and ¼ inches and said lengths are between 4 and 12 inches
